(19) United States
(12) Patent Application Publication
(10) Pub. No.: US 2023/0001375 A1
(43) Pub. Date: Jan. 5, 2023

(54) SYSTEMS, METHODS, AND DEVICES FOR PRODUCING A MATERIAL WITH DESIRED CHARACTERISTICS USING MICROWAVE PLASMA

(71) Applicant: 6K Inc., North Andover, MA (US)

(72) Inventors: Michael C. Kozlowski, Reading, MA (US); Jared Majcher, Portsmouth, NH (US); Makhlouf Redjdal, Melrose, MA (US); Pawel Matys, Jupiter, FL (US); Saurabh Ullal, Hollis, NH (US)

(21) Appl. No.: 17/808,967

(22) Filed: Jun. 24, 2022

Related U.S. Application Data
(60) Provisional application No. 63/202,921, filed on Jun. 30, 2021.
(60) Provisional application No. 63/267,469, filed on Feb. 2, 2022.

(51) Int. Cl. B01J 19/12

(52) U.S. Cl. CPC B01J 19/126; B01J 2219/0896; B01J 2219/1239; B01J 2219/0875; B01J 2219/0801

(57) ABSTRACT

The embodiments disclosed herein are directed to systems, methods, and devices for producing materials having desired characteristics using microwave plasma. In some embodiments, performing an iterative process may be used to produce a material having desired characteristics, the process comprising forming a microwave plasma within the reaction chamber, analyzing the plasma to determine if properties of the plasma are within a range expected to produce the desired characteristics of the material; and adjusting, based on the analysis of the plasma, one or more parameters. In some embodiments, an extension tube is provided within a microwave plasma apparatus to extend the length of a microwave plasma.

### INCORPORATION BY REFERENCE TO ANY PRIORITY APPLICATIONS

This application claims the priority benefit under 35 U.S.C. § 119(e) of U.S. Provisional Application No. 63/202,921, filed Jun. 30, 2021, and Provisional Application 63/267,469, filed Feb. 2, 2022, the entire disclosure of each of which is incorporated herein by reference. Any and all applications for which a foreign or domestic priority claim is identified in the Application Data Sheet as filed with the present application are hereby incorporated by reference under 37 CFR 1.57.

### BACKGROUND

### Field

The present disclosure is generally directed in some embodiments towards producing materials from feedstocks using a microwave plasma apparatus.

### Description

Novel systems, methods, and devices for producing materials with desired characteristics using microwave plasma are needed.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Some embodiments herein are directed to methods of processing a material in a microwave plasma to produce desired characteristics of the material, the method comprising: providing a microwave plasma apparatus comprising a reaction chamber; selecting at least one of the following parameters based on the desired characteristics of the material: microwave power, plasma gas flow rate, type of plasma gas, feed material size, feed material insertion rate, feed material inlet location, feed material inlet orientation, feed material inlet size, feed material inlet shape, number of feed material inlets, plasma temperature, swirl gas flow rate, type of swirl gas, or residence time; performing an iterative process comprising: forming a microwave plasma within the reaction chamber; injecting a feed material into a gas flow within the reaction chamber to direct the feed material into the plasma to produce a resulting material; analyzing the resulting material to determine if characteristics of the resulting material are within a threshold range of the desired characteristics; and adjusting, based on the analysis of the resulting material, one or more of the parameters; and repeating the iterative process until the characteristics of the resulting material are within the threshold range of the desired characteristics.

In some embodiments, the method further comprises quenching the microwave plasma prior to adjusting one or more of the parameters. In some embodiments, the microwave plasma is continuously formed until the characteristics of the resulting material are within the threshold range of the desired characteristics. In some embodiments, the microwave plasma comprises a length within the reaction chamber, the microwave plasma being at least partially confined by a tube extending downward within the reaction chamber along a portion of the length of the plasma. In some embodiments, the parameters further comprise: tube material, level of insulation of the reactor chamber or the tube, level of coating of the tube, or geometry of the tube. In some embodiments, the parameters comprise microwave power, plasma gas flow rate, swirl gas flow rate, or powder conveyance gas flow rate. In some embodiments, the parameters comprise type of plasma gas or type of swirl gas. In some embodiments, the parameters comprise feed material size, feed material insertion rate, feed material inlet location, feed material inlet orientation, feed material inlet size, feed material inlet shape, or number of feed material inlets.

In some embodiments, analyzing the resulting material comprises measuring a sphericity of the resulting material. In some embodiments, the desired characteristics of the material comprise the sphericity and the threshold range is a sphericity above 90%.

Some embodiments herein are directed to methods of processing a material in a microwave plasma to produce desired characteristics of the material, the method comprising: providing a microwave plasma apparatus comprising a reaction chamber; selecting at least one of the following parameters based on the desired characteristics of the material: microwave power, plasma gas flow rate, type of plasma gas, feed material size, feed material insertion rate, feed material inlet location, feed material inlet orientation, feed material inlet size, feed material inlet shape, number of feed material inlets, plasma temperature, swirl gas flow rate, type of swirl gas, or residence time; performing an iterative process comprising: forming a microwave plasma within the reaction chamber; analyzing the plasma to determine if properties of the plasma are within a range expected to produce the desired characteristics of the material ; and adjusting, based on the analysis of the plasma, one or more of the parameters; and repeating the iterative process until the properties of the plasma are within the range.

In some embodiments, the method further comprises quenching the microwave plasma prior to adjusting one or more of the parameters. In some embodiments, the microwave plasma is continuously formed until the properties of the plasma are within the range. In some embodiments, the microwave plasma comprises a length within the reaction chamber, the microwave plasma being at least partially confined by a tube extending downward within the reaction chamber along a portion of the length of the plasma. In some embodiments, the parameters further comprise: tube material, level of insulation of the reactor chamber or the tube, level of coating of the tube, or geometry of the tube.

In some embodiments, the parameters comprise microwave power, plasma gas flow rate, swirl gas flow rate, or residence time. In some embodiments, the parameters comprise type of plasma gas or type of swirl gas. In some embodiments, the parameters comprise feed material size, feed material insertion rate, feed material inlet location, feed material inlet orientation, feed material inlet size, feed material inlet shape, or number of feed material inlets.

Some embodiments herein are directed to methods of processing a material in a microwave plasma to produce particular characteristics of the material, the method comprising: providing a microwave plasma apparatus comprising a reaction chamber; forming a microwave plasma having a length within the reaction chamber, the microwave plasma being at least partially confined by a tube extending downward within the reaction chamber along a portion of the length of the plasma; and injecting a feed material into a gas flow within the reaction chamber to direct the feed material into the plasma without the gas flow rising into the tube and quenching the plasma.

In some embodiments, the method further comprises providing a non-stick coating on an interior surface of the reaction chamber. In some embodiments, the non-stick coating comprises tungsten carbide, chromium carbide, or nickel alloy. In some embodiments, the method further comprises agitating, oscillating, or vibrating the tube or the reaction chamber. In some embodiments, the tube tapers outward radially as the tube extends downward in the reaction chamber. In some embodiments, the tube comprises one or more cylindrical volumes extending downward in the reaction chamber. In some embodiments, the one or more cylindrical volumes are arranged in a stepped configuration, such that each successive cylindrical volume comprises a larger diameter than each previous cylindrical volume as the tube extends downward in the reaction chamber. In some embodiments, the microwave plasma is formed by providing microwave power to the microwave plasma apparatus. In some embodiments, the tube comprises one or more conical volumes extending downward in the reaction chamber. In some embodiments, the tube comprises a first conical volume and a second conical volume extending downward in the reaction chamber. In some embodiments, a widest portion of the first conical volume is connected to a widest portion of the second conical volume. In some embodiments, using two conical volumes further isolates the plasma from the surrounding environment which may prevent mixing of the hot plasma gases with relatively cooler gases within the reaction chamber leading to more uniform plasma temperature gradients. In some embodiments, more uniform plasma temperature gradients can produce a more homogenous process. A more homogenous process may allow for improved tailoring of materials during materials processing leading to a possibly more efficient process.

In some embodiments, the method further comprises increasing the microwave power provided to the microwave plasma apparatus. In some embodiments, forming the microwave plasma comprises flowing one or more gases into the reaction chamber and exposing the one or more gases to microwave power.

In some embodiments, the method further comprises altering the flow rate of the one or more gases into the reaction chamber. In some embodiments, the one or more gases comprises at least one of oxygen, nitrogen, or a noble gas. In some embodiments, the tube comprises stainless steel. In some embodiments, the tube or the reaction chamber is insulated with ceramic felt. In some embodiments, the tube comprises a length of between 12 inches and 18 inches. In some embodiments, the tube comprises a diameter of between 3 inches and 24 inches. In some embodiments, the feed material comprises tungsten, titanium, stainless steel, Inconel 625, or Inconel 718.

In some embodiments, the method further comprises selecting one of the following parameters based on the particular characteristics of the material: extension tube material, level of insulation of the reactor chamber or the extension tube, level of coating of the extension tube, or geometry of the extension tube.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates an embodiment of a microwave plasma torch that can be used in the production of materials according to some embodiments herein.

FIG. 2 illustrates an embodiment of a downstream portion of a microwave plasma torch, including an extension tube, which can be used in the production of materials according to some embodiments herein.

FIG. 3 illustrates another embodiment of a downstream portion of a microwave plasma torch, including an extension tube, which can be used in the production of materials according to some embodiments herein.

FIG. 4 illustrates an embodiment of an extension tube of a microwave plasma torch that can be used in the production of materials according to some embodiments herein.

FIG. 5 illustrates another embodiment of an extension tube of a microwave plasma torch that can be used in the production of materials according to some embodiments herein.

FIG. 6 illustrates another embodiment of an extension tube of a microwave plasma torch that can be used in the production of materials according to some embodiments herein

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

Disclosed herein are embodiments of methods, devices, and assemblies for forming materials from feedstocks using microwave plasma processing. Each different feedstock has its own critical, specialized, and unique requirements for microwave plasma processing to achieve desired material characteristics, such as spheroidization, morphology, aspect ratio, particle size distribution (PSD), chemistry, density, diameter, sphericity, oxygenation, hardness, and ductility, among others. As disclosed herein, processing in a microwave plasma torch can include feeding the feedstock into a microwave plasma torch, a plasma plume of the microwave plasma torch, and/or an exhaust of the microwave plasma torch. The feed location may vary depending on the desired material, as the feed location may affect the residence time and heat exposure of the feedstock, altering the material characteristics.

Some embodiments herein are directed to extending a microwave plasma within a microwave plasma torch. In some embodiments, extending the microwave plasma may comprise obtaining a plasma of sufficient length to process feedstocks to produce materials with desired material characteristics. Some embodiments herein are directed to tuning or altering, either automatically or manually, the length of a microwave plasma in order to obtain desired processing characteristics, including temperature profile and material residence time within a microwave plasma apparatus. In some embodiments, a microwave plasma apparatus according to the embodiments herein may comprise an extension tube that extends downward into a reaction chamber of the microwave plasma apparatus, the extension tube confining and directing the microwave plasma to extend its length. In some embodiments, the extension tube may concentrate the energy and power provided by a microwave power source, in order to form a longer microwave plasma within the apparatus.

In a conventional microwave plasma apparatus, a plasma may be formed by superheating and ionizing a plasma gas, and then directed downward into a reaction chamber, in which a feedstock material is provided to the plasma and processed into a material. The length of a plasma, plasma plume, or plasma exhaust in a conventional microwave plasma apparatus may be limited. For example, as the plasma extends downward in a reaction chamber away from the microwave power source, the plasma is cooled by surrounding gases, such that free electrons in the plasma recombine with the plasma gas atoms, causing the plasma to end. Furthermore, as the plasma extends further from the power source, insufficient energy is provided to the plasma gas, again causing the plasma to recombine into gas. Additionally, because the superheated plasma is less dense than the surrounding gases, the plasma naturally rises above the surrounding gases, which limits the length of plasma within the apparatus. Furthermore, in a conventional apparatus, the generated plasma may have length and shape that is extremely dynamic, as plasma does not generally maintain a fixed shape or volume.

To counteract these limitations in plasma length and stability, the methods and apparatuses described herein may utilize an extension tube, which extends downward from a core plasma tube into the reaction chamber. In some embodiments, the extension tube may concentrate energy from the microwave power source into a smaller volume, extending and directing the plasma at a greater length than would be possible using a conventional microwave plasma apparatus. In some embodiments, a length of a plasma may be tuned or altered by configuring one or more of the following parameters: power, plasma gas flow, type of gas, extension tube material, level of insulation of the reactor chamber or the extension tube, level of coating of extension tube, and geometry of the extension tube (e.g., tapered/stepped).

The process parameters can be optimized to obtain desired material characteristics. For each unique feedstock and desired material characteristics, process parameters can be optimized for a particular outcome. U.S. Pat. Pub. No. 2018/0297122, U.S. Pat. No. 8,748,785 B2, and 9,932,673 B2 disclose certain processing techniques that can be used in the disclosed process, specifically for microwave plasma processing. Accordingly, U.S. Pat. Pub. No. 2018/0297122, U.S. Pat. No. 8,748,785 B2, and 9,932,673 B2 are incorporated by reference in its entirety and the techniques describes should be considered to be applicable to the processes described herein.

The introduction of an extension tube into a microwave plasma apparatus may present additional processing challenges. For example, when the feedstock is heated by the plasma within the extension tube, the feedstock may adhere to the surfaces of the core tube (i.e., torch liner) or extension tube due to the proximity of the surfaces relative to the reactor chamber walls. This issue is particularly relevant for powder feedstock, which may stick to or coat the walls of the core tube or extension tube, which may undesirably affect the processing conditions and quality of the desired material. When the coating becomes too substantial in the core tube, the microwave energy is shielded from entering the plasma hot zone and plasma coupling is reduced. At times, the plasma may even extinguish and become unstable. Decrease of plasma intensity can result in a reduction in quality of a resulting material. In some embodiments, to prevent the feedstock from adhering to surfaces of the extension tube (or reaction chamber), a non-stick coating may be provided on those surfaces.

Furthermore, in some embodiments, an agitator, vibrator, or other device may be provided to prevent sticking and/or to remove feedstock particles from surfaces of the extension tube. In some embodiments, providing an extension tube with a specific shape may facilitate prevention of material accumulation on one or more surfaces of the microwave plasma torch. For example, a conical extension tube may prevent buildup on surfaces of the extension tube.

Another complication of providing an extension tube within the reaction chamber of the microwave plasma apparatus is that the extension tube may undesirably impact the circulation of gas within the microwave plasma apparatus. In particular, the extension tube may cause changes in system gas dynamics such that chamber gas is ingested into the plasma discharge area thereby reducing the processing power of the flame. This rising may undesirably quench the plasma being formed above. In some embodiments, in order to maintain proper gas circulation within the reaction chamber and prevent quenching of the plasma, the extension tube may be shaped, sized, and orientated such that the gas does not extinguish the plasma. For example, in some embodiments, the extension tube may be formed in the shape of a cone, or stepped, tapered, or otherwise shaped to allow proper gas circulation.

In some embodiments, an extension tube as described herein may extend downward into the reaction chamber of a microwave plasma apparatus. In some embodiments, the extension tube may extend downward at a length of at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or at least 100% of the reaction chamber length, or any value between the aforementioned values.

Some embodiments herein relate to systems, methods, and devices for processing a material in a microwave plasma to produce desired characteristics of the material using an iterative process. For example, in some embodiments, a microwave plasma apparatus comprising a reaction chamber may be provided. In some embodiments, at least one of the following parameters may be selected based on the desired characteristics of the material: microwave power, plasma gas flow rate, type of plasma gas, feed material size, feed material insertion rate, feed material inlet location, feed material inlet orientation, feed material inlet size, feed material inlet shape, number of feed material inlets, plasma temperature, swirl gas flow rate, type of swirl gas, or residence time.

In some embodiments, an iterative process may be performed comprising: forming a microwave plasma within the reaction chamber; injecting a feed material into a gas flow within the reaction chamber to direct the feed material into the plasma to produce a resulting material; analyzing the resulting material to determine if characteristics of the resulting material are within a threshold range of the desired characteristics; and adjusting, based on the analysis of the resulting material, one or more of the parameters. In some embodiments, the iterative process may be repeated until the characteristics of the resulting material are within the threshold range of the desired characteristics.

In some embodiments, an iterative process may comprise forming a microwave plasma within the reaction chamber; analyzing the plasma to determine if properties of the plasma are within a range expected to produce the desired characteristics of the material; and adjusting, based on the analysis of the plasma, one or more of the parameters. In some embodiments, the iterative process may be repeated until the properties of the plasma are within the range.

In some embodiments, the processes described herein may be completed manually by an operator of the microwave plasma apparatus. In some embodiments, the processes may be completed automatically using, for example, a controller comprising one or more hardware computer processors in communication with one or more computer readable storage devices and configured to execute the plurality of computer executable instructions. In some embodiments, the computer executable instructions may comprise an algorithm for automatically completing the iterative processes described herein to provide a material having desired characteristics. In some embodiments, artificial intelligence (AI) and/or machine learning (ML) may be utilized to automatically complete the iterative processes described herein to provide a material having desired characteristics.

In some embodiments, the controller, which may be in communication with various actuators and sensors of the microwave plasma apparatus, may receive input of the desired characteristics of the material from a user input device and control (e.g., by accessing a database or look-up table, or executing control processes associated with different inputs, or utilizing an algorithm such as an AI/ML algorithm) various components the apparatus to adjust various parameters. For example, the controller can receive a desired set of material characteristics and can select a feedstock and plasma processing parameters expected to produce the desired material characteristics. In some embodiments, the controller may direct an iterative process to produce the desired material characteristics, as discussed above.

### Microwave Plasma Apparatus

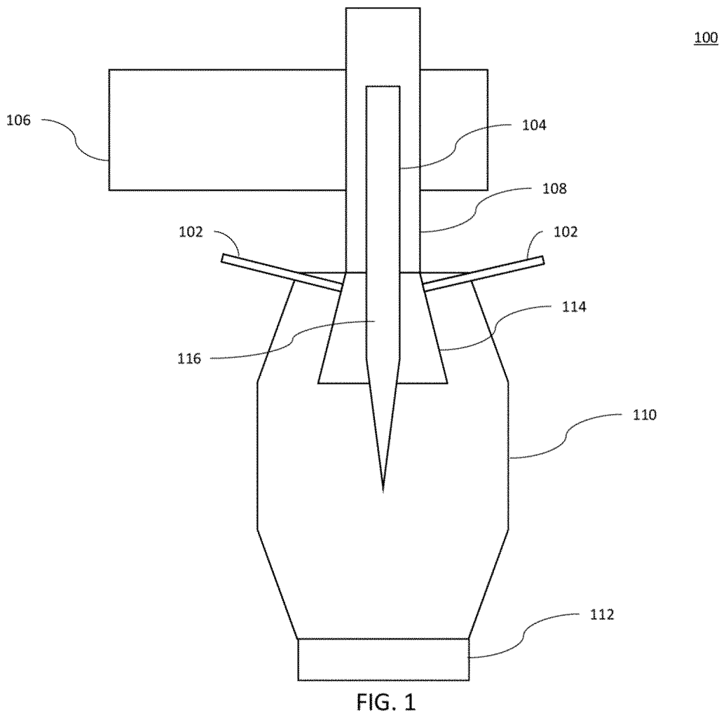

FIG. 1 illustrates an embodiment of a microwave plasma torch 100 that can be used in the production of materials according to some embodiments herein. In some embodiments, a feedstock can be introduced, via one or more feedstock inlets 102, into a microwave plasma 104. In some embodiments, an entrainment gas flow and/or a sheath flow may be injected into the microwave plasma torch 100 to create flow conditions within the plasma torch prior to ignition of the plasma 104 via microwave radiation source 106. In some embodiments, the entrainment flow and sheath flow are both axis-symmetric and laminar, while in other embodiments the gas flows are swirling. In some embodiments, the feedstock may be introduced into the microwave plasma torch 100, where the feedstock may be entrained by a gas flow that directs the materials toward the plasma 104.

As discussed above, the gas flows can comprise a noble gas column of the periodic table, such as helium, neon, argon, etc. Although the gases described above may be used, it is to be understood that a variety of gases can be used depending on the desired material and processing conditions. In some embodiments, within the microwave plasma 104, the feedstock may undergo a physical and/or chemical transformation. Inlets 102 can be used to introduce process gases to entrain and accelerate the feedstock towards plasma 104. In some embodiments, a second gas flow can be created to provide sheathing for the inside wall of a core gas tube 108 and a reaction chamber 110 to protect those structures from melting due to heat radiation from plasma 104.

Various parameters of the microwave plasma 104 may be adjusted manually or automatically in order to achieve a desired material. These parameters may include, for example, power, plasma gas flow rates, type of plasma gas, presence of an extension tube, extension tube material, level of insulation of the reactor chamber or the extension tube, level of coating of the extension tube, geometry of the extension tube (e.g. tapered/stepped), feed material size, feed material insertion rate, feed material inlet location, feed material inlet orientation, number of feed material inlets, plasma temperature, residence time and cooling rates. The resulting material may exit the plasma into a sealed chamber 112 where the material is quenched then collected.

In some embodiments, the feedstock is injected after the microwave plasma torch applicator for processing in the “plume” or “exhaust” of the microwave plasma torch. Thus, the plasma of the microwave plasma torch is engaged at the exit end of the plasma torch core tube 108, or further downstream. In some embodiments, adjustable downstream feeding allows engaging the feedstock with the plasma plume downstream at a temperature suitable for optimal melting of feedstock through precise targeting of temperature level and residence time. Adjusting the inlet location and plasma characteristics may allow for further customization of material characteristics. Furthermore, in some embodiments, by adjusting power, gas flow rates, pressure, and equipment configuration (e.g., introducing an extension tube), the length of the plasma plume may be adjusted.

In some embodiments, feeding configurations may include one or more individual feeding nozzles surrounding the plasma plume. The feedstock may enter the plasma from any direction and can be fed in 360° around the plasma depending on the placement and orientation of the inlets 102. Furthermore, the feedstock may enter the plasma at a specific position along the length of the plasma 104 by adjusting placement of the inlets 102, where a specific temperature has been measured and a residence time estimated for providing the desirable characteristics of the resulting material.

In some embodiments, the angle of the inlets 102 relative to the plasma 104 may be adjusted, such that the feedstock can be injected at any angle relative to the plasma 104. For example, the inlets 102 may be adjusted, such that the feedstock may be injected into the plasma at an angle of about 0 degrees, about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, or about 90 degrees relative to the direction of the plasma 104, or between any of the aforementioned values.

In some embodiments, implementation of the downstream injection method may use a downstream swirl or quenching. A downstream swirl refers to an additional swirl component that can be introduced downstream from the plasma torch to keep the powder from the walls of the core tube 108, the reactor chamber 110, and/or an extension tube 114.

In some embodiments, the length of a reaction chamber 110 of a microwave plasma apparatus may be about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

In some embodiments, the length of the plasma 104, which may be extended by adjusting various processing conditions and equipment configurations, may be about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

### Microwave Plasma Processing

In a microwave plasma process, the feedstock may be entrained in an inert and/or reducing gas environment and injected into the microwave plasma, the microwave plasma plume, or the microwave plasma exhaust. Upon injection into a hot plasma (or plasma plume or exhaust), the feedstock may undergo a physical and/or chemical transformation (e.g., spheroidization). After processing, the resulting material may be released into a chamber filled with an inert gas and directed into hermetically sealed drums where is it stored. This process can be carried out at atmospheric pressure, in a partial vacuum, or at a slightly higher pressure than atmospheric pressure.

In alternative embodiments, the process can be carried out in a low, medium, or high vacuum environment. The process can run in batches or continuously, with the drums being replaced as they fill up with processed material. By controlling the process parameters, such as cooling gas flow rate, residence time, plasma conditions, cooling gas composition, various material characteristics can be controlled.

Residence time of the particles within a hot zone of the plasma can also be adjusted to provide control over the resulting material characteristics. That is, the length of time the particles are exposed to the plasma determines the extent of melting of the feedstock particles (i.e., surface of the particle melted as compared to the inner most portion or core of the particle). Residence time can be adjusted by adjusting such operating variables of particle injection rate and flow rate (and conditions, such as laminar flow or turbulent flow) within the hot zone. Equipment changes can also be used to adjust residence time. For example, residence time can be adjusted by changing the cross-sectional area of the plasma, by, for example, extending the plasma. In some embodiments, extending the plasma may comprise incorporating an extension tube into the microwave plasma apparatus.

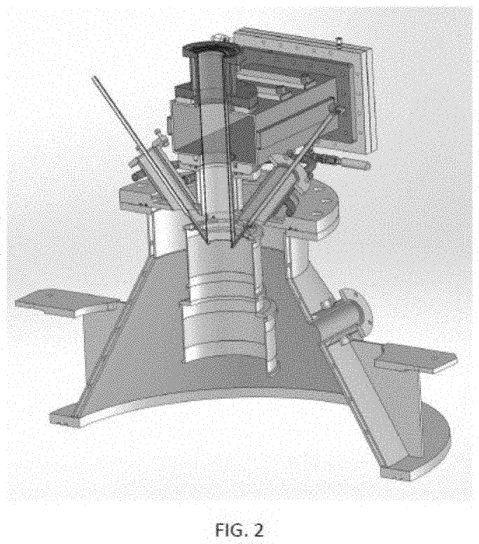

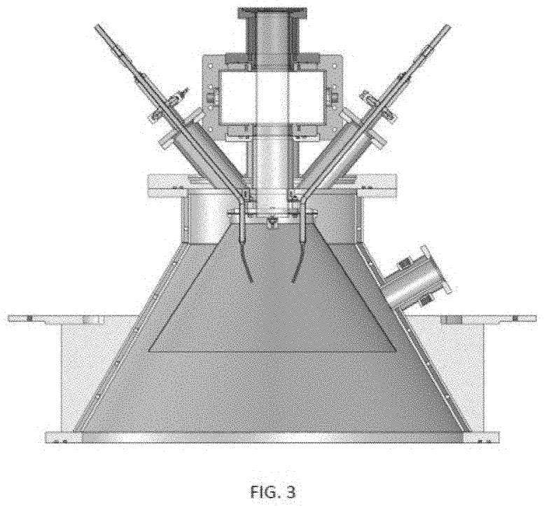

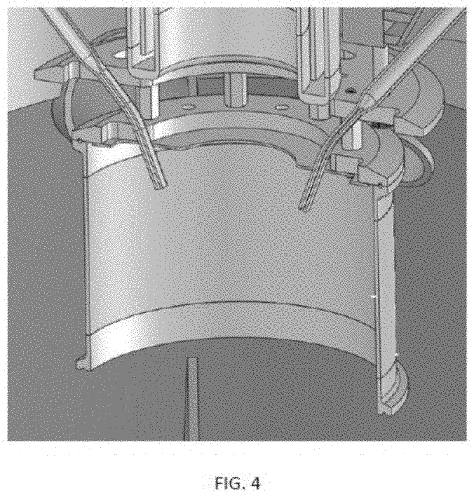

In some embodiments, the extension tube may extend into the reaction chamber of a microwave plasma apparatus, as shown in FIGS. 2-4. In some embodiments, the extension tube may comprise a stepped shape, such that the tube comprises one or more cylindrical volumes extending downward in the reaction chamber, wherein each successive cylindrical volume comprises a larger diameter than each previous cylindrical volume as the tube extends downward in the reaction chamber, as shown in FIG. 2. In some embodiments, the extension tube may have a conical shape, tapering radially outwards as it extends downward into the reaction chamber, as shown in FIG. 3. In some embodiments, the extension tube may comprise a single cylindrical volume, as shown in FIG. 4.

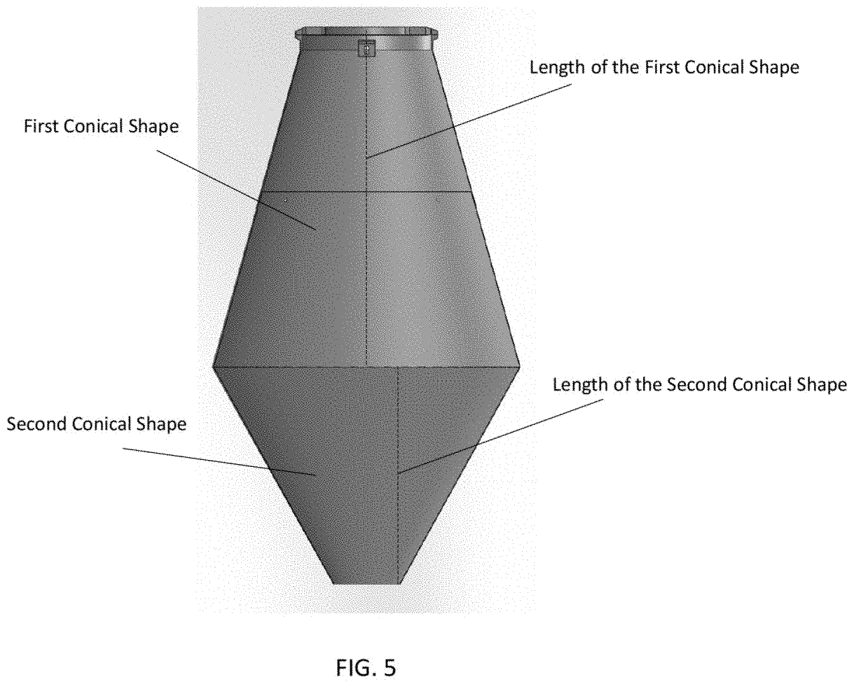

In some embodiments, the extension tube may have a dual conical shape, where the first conical shape tapers radially outwards as it extends downward into the rection chamber, and the second conical shape is an inverted asymmetrical shape to the first conical shape and is connected to the end of the first conical shape and tapers radially inwards as it extends downward into the reaction chamber as shown in FIG. 5. In some embodiments, the extension tube may comprise a dual conical shape, where the widest portion of the first conical shape is connected to the widest portion of the second conical shape as shown in FIG. 5. In some embodiments, the length of the first conical shape is greater than the length of the second conical shape as shown in FIG. 5.

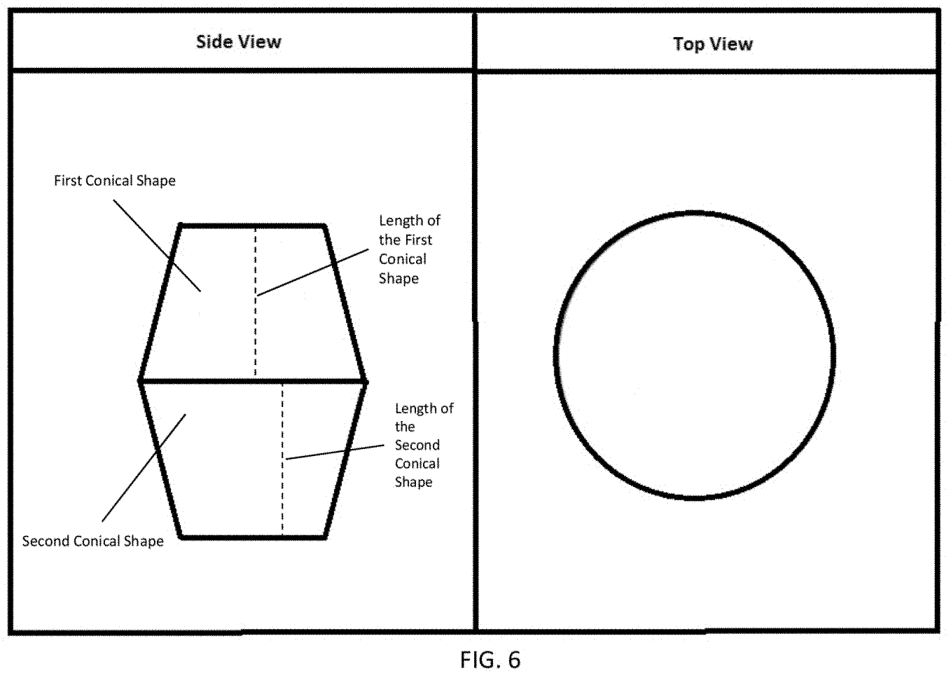

In some embodiments, the extension tube may have a dual conical shape, where the first conical shape tapers radially outwards as it extends downward into the reaction chamber and the second conical shape is an inverted symmetrical shape to the first conical shape and is connected to the end of the first conical shape and tapers radially inwards as it extends downward into the reaction chamber as shown in FIG. 6. In some embodiments, the widest portion of the first conical shape is connected to the widest portion of the second conical shape as shown in FIG. 6. In some embodiments, the length of the first conical shape is equal to the length of the second conical shape, as shown in FIG. 6. In some embodiments, the length of the second conical shape is greater than the length of the first conical shape. In some embodiments, the feed material inlets may insert feedstock within the extension tube.

In some embodiments, the extension tube may comprise a length of about 1 foot. In some embodiments, the extension tube may comprise a length of about 1 inch, about 2 inches, about 3 inches, about 4 inches, about 5 inches, about 6 inches, about 7 inches, about 8 inches, about 9 inches, about 10 inches, about 11 inches, about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

In some embodiments, the feedstock particles are exposed to a temperature profile at between 4,000 and 8,000 K within the microwave plasma. In some embodiments, the particles are exposed to a temperature profile at between 3,000 and 8,000 K within the microwave plasma. In some embodiments, one or more temperature sensors may be located within the microwave plasma torch to determine a temperature profile of the plasma.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A method of processing a material in a microwave plasma to produce desired characteristics of the material, the method comprising:
providing a microwave plasma apparatus comprising a reaction chamber;
selecting at least one of the following parameters based on the desired characteristics of the material: microwave power, plasma gas flow rate, type of plasma gas, feed material size, feed material insertion rate, feed material inlet location, feed material inlet orientation, feed material inlet size, feed material inlet shape, number of feed material inlets, plasma temperature, swirl gas flow rate, type of swirl gas, or residence time;
performing an iterative process comprising:
forming a microwave plasma within the reaction chamber;
injecting a feed material into a gas flow within the reaction chamber to direct the feed material into the plasma to produce a resulting material;
analyzing the resulting material to determine if characteristics of the resulting material are within a threshold range of the desired characteristics; and
adjusting, based on the analysis of the resulting material, one or more of the parameters; and
repeating the iterative process until the characteristics of the resulting material are within the threshold range of the desired characteristics.

2. The method of claim 1, further comprising quenching the microwave plasma prior to adjusting one or more of the parameters.

3. The method of claim 1, wherein the microwave plasma is continuously formed until the characteristics of the resulting material are within the threshold range of the desired characteristics.

4. The method of claim 1, wherein the microwave plasma comprises a length within the reaction chamber, the microwave plasma being at least partially confined by a tube extending downward within the reaction chamber along a portion of the length of the plasma.

5. The method of claim 1, wherein analyzing the resulting material comprises measuring a sphericity of the resulting material.

6. The method of claim 9, wherein the desired characteristics of the material comprise the sphericity, and wherein the threshold range is a sphericity above 90%.

7. A method of processing a material in a microwave plasma to produce desired characteristics of the material, the method comprising:
providing a microwave plasma apparatus comprising a reaction chamber;
selecting at least one of the following parameters based on the desired characteristics of the material: microwave power, plasma gas flow rate, type of plasma gas, feed material size, feed material insertion rate, feed material inlet location, feed material inlet orientation, feed material inlet size, feed material inlet shape, number of feed material inlets, plasma temperature, swirl gas flow rate, type of swirl gas, or residence time;
performing an iterative process comprising:
forming a microwave plasma within the reaction chamber;
analyzing the plasma to determine if properties of the plasma are within a range expected to produce the desired characteristics of the material; and
adjusting, based on the analysis of the plasma, one or more of the parameters; and
repeating the iterative process until the properties of the plasma are within the range.

8. The method of claim 7, further comprising quenching the microwave plasma prior to adjusting one or more of the parameters.

9. The method of claim 7, wherein the microwave plasma is continuously formed until the properties of the plasma are within the range.

10. The method of claim 7, wherein the microwave plasma comprises a length within the reaction chamber, the microwave plasma being at least partially confined by a tube extending downward within the reaction chamber along a portion of the length of the plasma.

11. A method of processing a material in a microwave plasma to produce particular characteristics of the material, the method comprising:
providing a microwave plasma apparatus comprising a reaction chamber;
forming a microwave plasma having a length within the reaction chamber, the microwave plasma being at least partially confined by a tube extending downward within the reaction chamber along a portion of the length of the plasma; and
injecting a feed material into a gas flow within the reaction chamber to direct the feed material into the plasma without the gas flow rising into the tube and quenching the plasma.

12. The method of claim 11, further comprising providing a non-stick coating on an interior surface of the reaction chamber.

13. The method of claim 12, wherein the non-stick coating comprises tungsten carbide, chromium carbide, or nickel alloy.

14. The method of claim 11, further comprising agitating, oscillating, or vibrating the tube or the reaction chamber.

15. The method of claim 11, wherein the tube tapers outward radially as the tube extends downward in the reaction chamber.

16. The method of claim 11, wherein the tube comprises one or more cylindrical volumes extending downward in the reaction chamber.

17. The method of claim 16, wherein the one or more cylindrical volumes are arranged in a stepped configuration, such that each successive cylindrical volume comprises a larger diameter than each previous cylindrical volume as the tube extends downward in the reaction chamber.

18. The method of claim 11, wherein the tube comprises one or more conical volumes extending downward in the reaction chamber.

19. The method of claim 11, wherein the tube comprises a first conical volume and a second conical volume extending downward in the reaction chamber.

20. The method of claim 19, wherein a widest portion of the first conical volume is connected to a widest portion of the second conical volume.
